(19) United States
(12) Patent Application Publication
(10) Pub. No.: US 2004/0012201 A1
(43) Pub. Date: Jan. 22, 2004

(54) Connecting fitting for peripherally ribbed longitudinal bodies with a locking retaining projecting element

(76) Inventors: Mario Bartholoma, Winden (DE); Fritz Zugel, Waldkirch (DE); Volker Gotz, Kenzingen (DE); Philipp Gerber, Gutach - Bleibach (DE)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/332,360

(22) PCT Filed: Jun. 29, 2001
(86) PCT No.: PCT/EP01/07430

(30) Foreign Application Priority Data
Jul. 6, 2000 (DE) 100 32 926.8

(51) Int. Cl. F16L 25/00

(52) U.S. Cl. 285/903

(57) ABSTRACT

A connecting filling (1) used for fixing peripherally ribbed longitudinal bodies such as corrugated hoses (2), comprising a retaining bushing (3) into which the longitudinal body or corrugated hose (2) can be inserted in an axial direction and anchored by means of at least one locking, retaining, projecting element which, when insertion occurs, is radially offset in an outer direction and engages with a recess running along the periphery of the longitudinal body or corrugated hose (2), for instance a corrugation trough (2a). A retaining ring (4) which is fixed in an axial direction inside the retaining bushing (3) is used as a retaining projecting element. The ring can be expanded in an elastic manner in a radial direction until the inner diameter thereof is at least as large as the largest outer diameter of the longitudinal body or an undulation of the corrugated hose (2). The retaining ring (4) can be offset when the corrugated hose (2) is inserted and can engage with a recess or a corrugation trough (2a). The periphery of a plastic or metal retaining ring (4) is interrupted by a slit (5) which widens when the ring is expanded. An oblique or funnel-shaped surface (4a) enables the ring to be automatically expanded when the longitudinal body to be anchored or corrugated hose (2) is pressed against said surface in an axial direction.

The invention relates to a connecting fitting for peripherally ribbed longitudinal bodies, such as tubes, hoses, or cables, in particular for corrugated hoses, having a retaining bushing into which the longitudinal body or corrugated hose can be inserted axially and can be anchored by at least one retaining projection that spreads radially outward during the insertion and then locks into a recess, in particular into a corrugation trough, that runs along its periphery.

A connecting fitting of this sort is known from DE 39 03 353 and from EP 0 381 979 B1, and has proved reliable. Here, elastically deformable tongues are provided on the bushing, each having a projection that protrudes into the inner cross-section of the bushing. During insertion of the longitudinal body or corrugated hose, this projection can spread and then lock into a recess or corrugated trough that runs around the periphery. This yields an only partially effective anchoring on the periphery of the longitudinal body. Moreover, the manufacture of such retaining bushings, having holding tongues that are situated thereon in one piece and that can flex in relation to the surface thereof, requires an expensive tool.

The invention is thus based on the object of creating a connecting fitting of the type defined above, in whose use the anchoring of the longitudinal body or corrugated hose is effective over a larger peripheral area, and the manufacture at least of the retaining bushing is simpler.

This object is achieved in that at least one retaining ring, fixed in the axial direction, is situated in the interior of the retaining bushing as a retaining projecting element, which ring can be elastically expanded within its mounting in the radial direction, at least far enough that its inner cross-section corresponds to the largest outer cross-section of the longitudinal body, or to a corrugation of the corrugated hose or the like, so that this ring spreads during the insertion of the longitudinal body or of the corrugated hose, and can be locked with a recess or a corrugation trough.

Thus, a preferably separate retaining ring can be situated inside the retaining bushing, simplifying the manufacture thereof. This retaining ring can be fixed in the axial direction, i.e., it can be locked or secured to the greatest possible extent against axial displacements, but spreads in the radial direction, widening its inner cross-section, when the peripherally ribbed longitudinal body is inserted. If a recess or a corrugation trough behind a peripheral rib is pushed into the region of this retaining ring, the ring can engage and lock therein automatically due to its elasticity, and thus fixes the longitudinal body in the axial direction, because it is itself likewise fixed in the axial direction. Thus, the longitudinal body can be fixed inside the connecting fitting and the retaining bushing thereof and is no longer accessible from the outside (or not without taking further measures), and thus cannot be detached in an undesired fashion. At the same time, here the longitudinal body is anchored over a large peripheral area, determined by the relaxed retaining ring and the inner periphery thereof.

It is particularly useful if the retaining ring is interrupted on its periphery by a slit that extends across its entire cross-section, and can thus be expanded by widening the slit. This enables the use above all of plastic retaining rings that have a good intrinsic strength, but whose slit also enables elastic expansion and automatic return to the initial position for locking. Besides one or more such retaining rings made of plastic, one or more retaining rings made of metal are however also possible.

The width of the slit of the retaining ring can be dimensioned such that given mutual contact of the two limits of the slit, i.e., when this slit is closed, the outer dimension of the retaining ring is equal to or larger than the narrowest point of the retaining bushing in the direction of withdrawal of the corrugated hose. In this way, it can be ensured that the retaining ring is not deformed too much inwardly in the radial direction, and can subsequently be withdrawn from the bushing, for example together with the longitudinal body. Even without the longitudinal body, in this way an undesired removal of the retaining ring from its mounted position in the bushing is prevented, so that in this way it is captive. Here, normally a deformation of the retaining ring in such a way that its slit is completely closed is not possible when the longitudinal body has been introduced into the retaining ring.

The slit can interrupt the retaining ring so as to extend radially or obliquely. Here, a slit extending approximately radially can be produced more easily, while an oblique slit has the effect that, despite the slitting of the ring, due to a certain overlapping of the surfaces limiting the slit a closed retaining ring is present overall.

A significant and advantageous construction of the present invention can be that the face of the retaining ring facing the direction of insertion of the longitudinal body or corrugated hose can taper off, over at least a part of its radial width, obliquely towards the center of the retaining ring, and in particular has a conical or funnel shape. This facilitates the expansion in the radial direction of the retaining ring, which cannot practically be accessed from the outside, solely through the insertion of the longitudinal body, which first meets this approximately funnel-shaped face of the still-undeformed ring. The force exerted in the insertion onto the oblique face surface is converted, via the oblique surfaces, into the desired radial deformation.

Here, the thickness or axial dimension of the retaining ring on its inner side, or its inner diameter, can be smaller than the axial dimension of the corrugated hose, and its greatest thickness, situated further outward radially, can be greater than the axial dimension of a recess or of a corrugation trough. In this way, a centering effect is simultaneously produced on the longitudinal body by the retaining ring, which locks again into a recess or a corrugation trough; i.e., an axial positioning is effected. The cross-section of the ring thus tapers conically towards the center somewhat, and thus fits into a recess or a corrugation trough, but further outward is wider than such a recess or such a corrugation trough, so that in this way it comes to be seated on both edges of this recess or of this corrugation trough.

In addition, at its face facing the direction of insertion, the retaining ring can have a thickness that decreases, starting from its point of greatest axial thickness and moving outward to its greatest diameter; in particular, it can have an oblique surface or a bevel, and the point of mounting in the retaining bushing can be formed as an annular groove whose limit is shaped obliquely, at least on the side of this oblique surface of the retaining ring, in particular in the analogous direction, and the diameter of the annular groove can be greater than the outer diameter of the retaining ring by at least such an extent that when the longitudinal body or the corrugated hose is introduced, or when the longitudinal body or corrugated hose is detached, the retaining ring is located with its inner diameter at least onto the greatest outer diameter of the peripheral rib or corrugation overlapped by the retaining ring in its position of use. The annular groove, situated in the bushing, for accepting the retaining ring is thus larger at its periphery, or at its base, than the relaxed retaining ring, so that this ring can be expanded inside this annular groove in order to enable the longitudinal body or corrugated hose to pass through.

A simplification of the handling of the connecting fitting, and in particular of the possibility of detaching the longitudinal body or corrugated hose from the retaining bushing, can be achieved in that a detachment tool that extends into the area of the retaining ring is situated on the retaining bushing and is used to expand the retaining ring against its elastic resetting force. In this way, a widening is possible, thus making the passage through the retaining ring large enough to permit the peripheral ribs or corrugations to be pushed through, both during the insertion of the longitudinal body, with the aim of effecting a locking not immediately at the first recess but rather at one situated further back in the direction of insertion, and also during disassembly of the retaining ring using the detachment tool. If the detachment tool is then moved back or disengaged, the retaining ring can again exercise its retaining function.

A very useful specific embodiment of the connecting fitting with detachment tool can be that the detachment tool is formed as a lid-type termination of the retaining bushing, in particular on the side of insertion for the longitudinal body or corrugated hose, with the termination having a collar or support, or individual fingers, extending inwardly into the retaining bushing, preferably having a conical shape at the free end or edge, that impinges on or grasps from behind the radially inwardly oriented oblique surface on the retaining ring, at least when this detachment tool is being pushed in axially, the axial movability for this detachment tool and the angle or angles of the cooperating oblique surfaces being selected such that, due to the axial meeting with the detachment tool, the retaining ring can be widened radially out of the region of the recess or corrugation. Likewise, using the detachment tool this ring can of course also be widened before an longitudinal body or corrugated hose is inserted, so that this body or hose can be inserted more deeply than up to its first recess or first corrugated trough. The funnel-shaped oblique surface on the face of the retaining ring is thus used for the axial impingement on this ring either via the longitudinal body itself or else via the detachment tool, thus effecting a radial expansion.

The underside of the retaining ring, situated opposite the direction of insertion, can likewise be inclined from the outside towards the inside, and can run obliquely at least over a part of the width, preferably over the entire radial width, of the retaining ring, so that the ring cross-section has a conical shape overall, at least in the area that engages in a recess or in a corrugated trough.

Here, the second limit, facing away from the oblique limit of the annular groove that accepts the retaining ring, can lift and can be situated in a radial plane, and the radially external edge area of the retaining ring can impinge on, or lie on, this planar limit of the annular groove, at least during the insertion process. During its elastic recovery, this outer edge area then glides on the approximately planar limit of the annular groove, and thus cannot become stuck on surface roughnesses of this limit, and thus securely achieves its anchored position. Simultaneously, this bevel also facilitates the automatic engagement in a recess or a corrugation trough of the face of the retaining ring facing away from the direction of insertion, even if the mutual axial positioning is not completely precise.

Above all, the features and measures described above, individually or in combination, result in a connecting fitting with which in particular corrugated hoses, but also other bodies provided with peripheral ribs, can easily be connected in positively locking fashion through insertion, while a subsequent detachment is also nonetheless possible, but is not as easily identifiable for unauthorized persons as is the case for retaining bushings having retaining tongues that can be bent outward radially. At the same time, a largely symmetrical mounting is enabled practically over the entire periphery of the longitudinal body, while the manufacture of the retaining bushing and the tool required for this purpose can nonetheless be simplified.

In the following, a preferred embodiment of the present invention is described in more detail on the basis of the drawings. The following are shown in partially schematic representations:

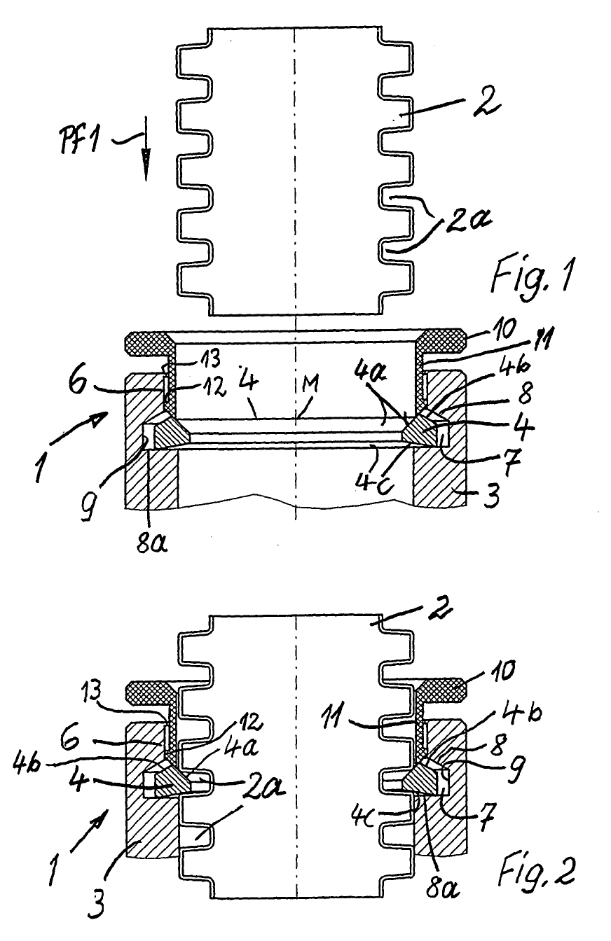

FIG. 1 is a longitudinal section of a retaining bushing, partially broken away in the axial direction in the drawing, of a connecting fitting for a corrugated hose, a radially expandable retaining ring as well as a detachment tool engaging therewith being provided in the interior of the retaining bushing in order to form the connecting fitting for the corrugated hose,

FIG. 2 is a view corresponding to FIG. 1 after the insertion and locking of the corrugated hose, which is thereby fixed inside the connecting fitting in the axial direction,

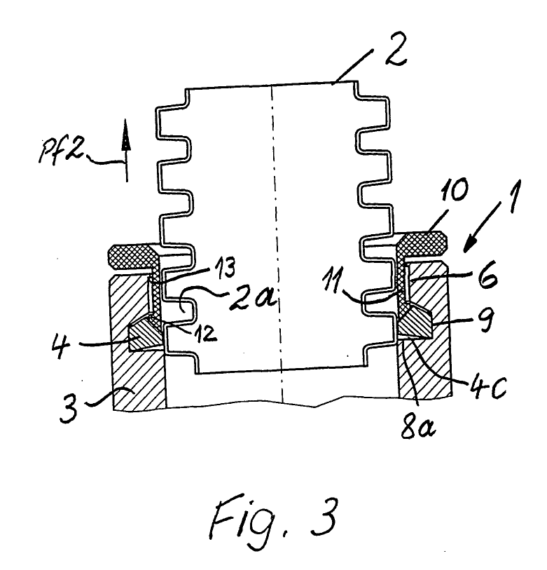

FIG. 3 is a view corresponding to FIGS. 1 and 2, in which the detachment tool is pressed into the retaining bushing in the axial direction, and the retaining ring, on which this detachment tool impinges, is thereby expanded radially so far that the corrugated hose can be withdrawn against the direction of insertion without resistance, through the correspondingly widened inner opening of this retaining ring,

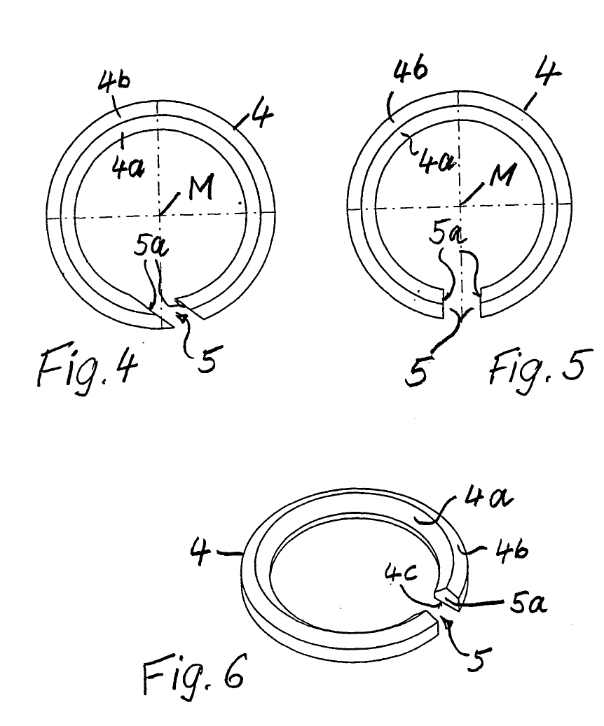

FIG. 4 is a top view of a specific embodiment of the retaining ring having an oblique slit that interrupts the periphery of the retaining ring,

FIG. 5 is a top view of a modified retaining ring having a slit extending in the radial direction, and

FIG. 6 is a graphic representation of the retaining ring according to FIG. 5.

A connecting fitting, designated as a whole with 1, is used for the fixing or fastening or coupling of peripherally ribbed longitudinal bodies, i.e., objects whose outer surface has alternating annular projections and recesses, for example corrugated hoses 2 as shown in the preferred embodiment.

This connecting fitting 1 has a retaining bushing 3 into which the longitudinal body, i.e., corrugated hose 2 in the embodiment shown, can be inserted axially and anchored by a retaining projecting element (described later).

Here, as a retaining projecting element at least one retaining ring 4, mounted or fixed in the interior of retaining bushing 3 in the axial direction, is used, which can be elastically expanded in the radial direction inside its mounting so far that its inner cross-section or inner diameter corresponds to the greatest outer cross-section of the longitudinal body or corrugated hose 2, so that during the insertion of corrugated hose 2 in the direction of arrow Pf1 (shown in FIG. 1) this ring spreads and is enlarged radially so far that the corrugation or corrugations of the corrugated hose can pass through this retaining ring 4. If a recess or corrugation trough 2a reaches the area of retaining ring 4, it can lock into this ring due to its elasticity, thus fixing corrugated hose 2 inside retaining bushing 3 in the axial direction.

According to FIGS. 4 to 6, the periphery of retaining ring 4 is interrupted by a slit 5, and can thus be expanded by a widening of this slit 5. Both in the preferred embodiment according to FIG. 4 and also according to FIG. 5, the width of this slit 5 is dimensioned such that, given mutual contacting of limits 5a at both sides of slit 5, i.e., when slit 5 is completely pressed together, the outer dimension or the greatest diameter of retaining ring 4 is larger than the narrowest point 6 of retaining bushing 3, situated in the direction of withdrawal (opposite arrow Pf1) of corrugated hose 2. If corrugated hose 2, which in the position of use is fixed inside retaining bushing 3, is loaded with a tensile force opposed to the direction of insertion, retaining ring 4 can thus in no case be pressed together radially to such an extent that it can move out of its mounted position.

Here, FIGS. 4 and 5 show that slit 5 can interrupt retaining ring 4 radially (FIGS. 5 and 6), or so as to run obliquely (FIG. 4).

In all embodiments shown, the face of retaining ring 4 that faces the direction of insertion, according to Pf1, of corrugated hose 2 slopes in beveled fashion over a part of its radial width, towards the center M of retaining ring 4; in the preferred embodiment it has a conical or funnel shape. This can be seen particularly clearly in FIGS. 1 to 3, as well as in FIG. 6. In the initial position, before the mounting of corrugated hose 2, this funnel surface 4a extends into the inner cross-section of retaining bushing 3, as can be seen clearly in FIG. 1. If corrugated hose 2 is pushed in in the direction of arrow Pf1, its first corrugation or peripheral rib impacts against this funnel surface 4a, where the axial movement and force are converted at least partially into a radial force that expands retaining ring 4 in the radial direction, so that a simple plugging motion of corrugated hose 2 is sufficient to introduce it into retaining bushing 3, thereby widening retaining ring 4, which can then lock into one of the next corrugation troughs 2a, if the pressure force in the direction of arrow Pf1 on corrugated hose 2 is halted.

Here, it is clear above all on the basis of FIG. 2 that the axial dimension of retaining ring 4 on its inner side, or its inner diameter, is smaller than the axial dimension of a corrugation trough 2a of corrugated hose 2 or the like, and its greatest thickness, situated radially further outward, is greater than the axial dimension of a recess or of a corrugated trough 2a. This makes it possible for retaining ring 4 to enter into such a recess or corrugated trough 2a with its part situated radially further inward, but also still to protrude radially past this recess or trough somewhat. According to FIG. 2, here approximately half of funnel surface 4a engages in a corrugation trough 2a.

So that, given a tensile force on corrugated hose 2, and in particular given an increasing tensile force, the retaining force of retaining ring 4 will likewise increase, retaining ring 4 has on its face facing the direction of insertion, on which funnel surface 4a is situated, a thickness that decreases, starting from its point of greatest axial thickness and going outward towards its greatest diameter, having in the exemplary embodiment an oblique surface or bevel 4b. The bearing point in retaining bushing 3 is formed as annular groove 7, and its limit 8 facing the narrowest point 6 of retaining bushing 3, situated on the side of this beveled surface 4b of retaining ring 4, is likewise shaped obliquely in the analogous direction and with practically the same angle according to FIGS. 1 to 3, so that according to FIG. 3 beveled surface 4b can lie largely in planar fashion against this limit 8. Thus, if a tensile force directed against arrow Pf1 is exerted on corrugated hose 2, beveled surface 4b can come to rest on limit 8, and such a tensile force can be converted into a force directed radially inwards on retaining ring 4, so that given increasing tensile force this ring is pressed the more strongly into corrugation trough 2a on which it impinges.

Simultaneously, in FIGS. 1 and 2 it can be seen that the diameter of annular groove 7 is greater than the outer diameter of retaining ring 4 by at least such an amount that retaining ring 4, during the insertion of corrugated hose 2 or during its detachment (described below), is with its inner diameter at least onto the largest outer diameter of peripheral rib or corrugation of corrugated hose 2 grasped by retaining ring 4 in the position of use, before the greatest outer diameter of retaining ring 4, in its expanded shape, comes into contact with radial limit 9 of annular groove 7. In FIG. 3, it can be seen that when retaining ring 4 has its greatest expansion, i.e., when a corrugation of corrugated hose 2 is situated on the inner side of retaining ring 4, the outer side of retaining ring 4 just touches this radial limit 9 of annular groove 7.

So that a simple disassembly of corrugated hose 2 is also possible at any time, in the preferred embodiment according to FIGS. 1 to 3, a detachment tool 10 that extends into the area of retaining ring 4 is situated on retaining bushing 3, which tool is used to expand retaining ring 4 against its elastic reset force, i.e., from its retaining position according to FIG. 2 into the expanded position according to FIG. 3.

This detachment tool 10 is here formed and situated as a lid-type termination of retaining bushing 3, on the side of insertion for corrugated hose 2. This termination, formed as a detachment tool 10, here has a collar or support 11 that protrudes inwardly into retaining bushing 3, which collar or support can also be divided by slits into individual fingers or tongues, and has on its end a conical tapered shape that impinges on and overlaps the radially inwardly directed oblique or funnel-shaped surface 4a on retaining ring 4, at least when this detachment tool 10 is pushed in axially. The axial movability for this detachment tool 10 and the angle or angles of the cooperating oblique surfaces are selected such that retaining ring 4 can be widened radially out of the area of the recess or of a corrugated trough 2a, as is shown clearly in FIG. 3. Here, the collar or support 11 of detachment tool 10 has a projecting element 12 that protrudes radially outward and is usefully peripheral, and retaining bushing 3 has a counter-projection 13 that protrudes radially inwards, so that detachment tool 10 is held in captive fashion on retaining bushing 3, because given a pulling movement on detachment tool 10 against arrow Pf1, projecting element 12 will impact counter-projection 13, so that a safeguard against withdrawal of detachment tool 13 in the axial direction is formed.

In the preferred embodiment, lower side 4c of retaining ring 4, opposite the direction of insertion, is likewise sloped from the outside to the inside, over the entire radial width of retaining ring 4. Here the direction of the inclination is such that the ring cross-section has a conical shape overall in the area that engages in a recess or in a corrugated trough 2a. The direction of the inclination on the lower side 4c is thus selected such that the axial dimension on the inner side of retaining ring 4 is further reduced than would be the case if such an inclined lower side 4c were not present.

In the preferred embodiment, the second limit 8a, facing away from oblique limit 8 of annular groove 7, is planar, and is situated in a radial or diametral plane of retaining bushing 3, so that retaining ring 4 impinges on or rests on this planar limit 8a of annular groove 7 with its radially outer edge area, at least during the insertion process. Practically, there thus results on this side of retaining ring 4 only one linear area of contact, which makes it easier for retaining ring 4 to return automatically to its initial position after expansion, due to its elasticity, because this lower side 4c, which is obliquely shaped in cross-section, can glide easily over possible rough spots of limit 8a, or even parts of this limit that are uneven. In addition, the entry into a corrugation trough 2a is facilitated even if this entry is displaced axially somewhat in relation to second limit 8a, as indicated in FIG. 2.

For the assembly of corrugated hose 2, according to FIG. 1 this hose can thus be pushed in the direction of arrow Pf1 through detachment tool 10, which has a correspondingly large inner longitudinal cavity. Here, a corrugation of corrugated hose 2 meets funnel surface 4a of retaining ring 4, and pushes this surface in the radial direction until a corrugation trough 2a moves into the area of retaining ring 4. Due to the elastic reset force of the preferably metallic retaining ring 4, this ring then springs automatically into such a corrugation trough 2a. If the corrugated hose is to be pushed in deeper, the next corrugation can again expand retaining ring 4 at its funnel surface 4a, so that it is situated for example with two corrugations behind retaining ring 4, as shown in FIG. 2.

If retaining ring 4 is to be disassembled, the detachment tool 10 is pressed into retaining bushing 3 in the axial direction from the position shown in FIG. 2, in the direction of arrow Pf1 in FIG. 1, so that its conically tapered collar or support 11 at the end or edge on funnel surface 4a becomes effective and again expands retaining ring 4, as shown in FIG. 3. In this way, the inner cross-section inside the retaining bushing in the area of retaining ring 4 is enlarged in such a way that the corrugations of corrugated hose 2 can pass through; i.e., corrugated hose 2 can be withdrawn in the direction of arrow Pf2.

It should also be noted that the angle of beveling on lower side 4c of retaining ring 4 is acute or small enough in relation to a diametral plane that a tensile force on corrugated hose 2 cannot result in a radial expansion of retaining ring 4; rather, there is a self-locking effect. In addition, it can be seen that the radial width of beveled surface or funnel surface 4a is large enough to engage partially in a corrugation trough 2a, but also in this position to enable the application of detachment tool 10 and its conical edge.

The connecting fitting 1 is used to fix peripherally ribbed longitudinal bodies, such as for example corrugated hoses 2, and has a retaining bushing 3 into which the longitudinal body or corrugated hose 2 can be inserted in the axial direction and can be anchored by at least one retaining projecting element that spreads outward radially during insertion and then locks into a recess, for example into a corrugation trough 2a, that runs around the periphery of the longitudinal body or corrugated hose 2. Here, as a retaining projecting element, a retaining ring 4 is used that is fixed in the axial direction in the interior of retaining bushing 3, which ring can however be expanded elastically in the radial direction far enough that its inner cross-section corresponds at least to the largest outer cross-section of the longitudinal body, or of a corrugation of corrugated hose 2. In this way, during the insertion of corrugated hose 2, the retaining ring 4 can expand, and can then lock in a recess or a corrugated trough 2a. A retaining ring 4 made of plastic or metal is interrupted on its periphery by a slit 5, so that its expansion effects a widening of this slit 5. A beveled or funnel surface 4a, opposed to the direction of insertion, enables the automatic widening of this retaining ring when the longitudinal body or corrugated hose 2 to be anchored is pressed against it axially.

1. Connecting fitting (1) for peripherally ribbed longitudinal bodies such as tubes, hoses, or cables, in particular for corrugated hoses (2), having a retaining bushing (3), into which a longitudinal body or corrugated hose can be inserted axially and can be anchored by at least one retaining projection that spreads outward radially during axial insertion and then locks into a recess, in particular into a corrugation trough (2a), that runs along a periphery of the body or hose, characterized in that
at least one retaining ring (4), fixed in the axial direction, is situated in an interior of the retaining bushing (3) as a retaining projection, the ring being elastically expanded, within a mounting in the retaining bushing in a radial direction, at least to a point at which an inner cross-section thereof corresponds to a greatest outer cross-section of the longitudinal body or hose, or to a corrugation of the corrugated hose (2), so that the ring spreads during insertion of the longitudinal body or the corrugated hose (2), and can be locked with a recess or a corrugation trough (2a).

2. Connecting fitting as recited in claim 1, characterized in that the periphery of the retaining ring (4) is interrupted by a slit (5), and can be expanded by widening the slit.

3. Connecting fitting as recited in claim 1 or 2, characterized in that the width of the slit (5) of the retaining ring (4) is dimensioned such that, given mutual contact of limits (5a) at both sides of the slit (5), an outer dimension of the retaining ring (4) is equal to or greater than a narrowest point (6) of the retaining bushing (3) in a direction of withdrawal of the corrugated hose (2).

4. Connecting fitting as recited in one of claims 1 to 3, characterized in that the slit (5) interrupts the retaining ring (4) and extends radially or obliquely.

5. Connecting fitting as recited in one of claims 1 to 4, characterized in that a face of the retaining ring (4) facing the direction of insertion of the longitudinal body or corrugated hose (2) is shaped so as to be inclined obliquely, over at least a part of a radial width thereof, towards a center (M) of the retaining ring (4), and has in particular a conical or funnel shape.

6. Connecting fitting as recited in one of claims 1 to 5, characterized in that a thickness or axial dimension of the retaining ring (4) at an inner side thereof, or its inner diameter, is smaller than an axial dimension of a corrugation trough (2a) of the corrugated hose (2), and a greatest thickness thereof situated further outward radially is greater than an axial dimension of a recess or of a corrugation trough (2a).

7. Connecting fitting as recited in one of claims 1 to 6, characterized in that on a face facing the direction of insertion, the retaining ring (4) has a thickness that decreases, starting from a point of greatest axial thickness and moving outward to a greatest diameter, having in particular an oblique surface or a bevel (4b), and a point of mounting in the retaining bushing (3) is formed as an annular groove (7) whose limit (8) is shaped obliquely, at least on a side of the oblique surface (4b) on the retaining ring, in particular in a complementary direction, and that a diameter of the annular groove (7) can be greater than an outer diameter of the retaining ring (4) by at least such an extent that when the longitudinal body or the corrugated hose (2) is introduced, or when the longitudinal body or corrugated hose (2) is detached, an inner diameter of the retaining ring, at least onto the greatest outer diameter of the peripheral rib or corrugation, overlapped in a position of use.

8. Connecting fitting as recited in one of claims 1 to 7, characterized in that a detachment tool (10) that protrudes into an area of the retaining ring (4) is situated on the retaining bushing (3), and is used to expand the retaining ring (4) against an elastic reset force.

9. Connecting fitting as recited in one of claims 1 to 8, characterized in that the detachment tool (10) is formed as a lid-type termination of the retaining bushing (3), in particular on an insertion side for the longitudinal body or corrugated hose (2), the termination having a collar or support (11) or individual fingers extending inwardly into the retaining bushing (3), preferably having a conical shape at a free, axially inner, end or edge thereof, that impinges on or overlaps the radially inwardly oriented oblique surface or funnel surface (4a) on the retaining ring (4), at least when the detachment tool (10) is pushed in axially, the axial movability for the detachment tool (10) and the angle or angles of cooperating oblique surfaces being selected such that the retaining ring (4) can be widened radially out of a region of the recess or of a corrugation trough (2a).

10. Connecting fitting as recited in claim 8 or 9, characterized in that the collar or support (11) of the detachment tool (10) has at least one projecting element (12) that protrudes radially outward, in particular peripherally, and the retaining bushing (4) has a counter-projection element (13) that protrudes radially inward.

11. Connecting fitting as recited in one of claims 1 to 10, characterized in that a lower side (4c), opposed to the direction of insertion, of the retaining ring (4) is inclined from an outside towards an inside thereof, and extends obliquely at least over a part of a width thereof, preferably over an entire radial width, so that a cross-section of the ring is conical overall at least in an area that engages in a recess or in a corrugation trough (2a).

12. Connecting fitting as recited in one of claims 1 to 11, characterized in that a second limit (8a), facing away from the oblique limit (8) of the annular groove (7), is planar and is situated in a radial plane, and the retaining ring (4) impacts or comes to lie on the second limit of the annular groove (7) with a radially outer edge area thereof, at least during insertion.
